(19) United States
(12) Patent Application Publication
(10) Pub. No.: US 2014/0261536 A1
(43) Pub. Date: Sep. 18, 2014

(54) DUST MITIGATION DEVICE AND METHOD OF MITIGATING DUST

(71) Applicants: Charles R. Buhler, Cocoa Beach, FL (US); Carlos I. Calle, Merritt Island, FL (US); Judson Sidney Clements, Boone, NC (US)

(72) Inventors: Charles R. Buhler, Cocoa Beach, FL (US); Carlos I. Calle, Merritt Island, FL (US); Judson Sidney Clements, Boone, NC (US)

(21) Appl. No.: 14/212,452

(22) Filed: Mar. 14, 2014

Related U.S. Application Data
(60) Provisional application No. 61/792,826, filed on Mar. 15, 2013.

(51) Int. Cl. B08B 6/00; B08B 17/02

(52) U.S. Cl. CPC B08B 6/00; B08B 17/02
USPC 134/1; 15/1.51

(57) ABSTRACT

The invention includes a dust mitigation device that utilizes electromagnetic waves to protect devices from dust deposition. The device includes a nonconducting (dielectric) material separating at least one electrode, and in some embodiments a plurality of electrodes, from a grounded layer. The electrodes are connected to a single phase AC signal or a transient voltage signal. In some embodiments the grounded layer is created using a continuous conductor or a conductive grid. In some embodiments, the dielectric, the electrodes, and/or the grounded layer are transparent. The electromagnetic fields produced by the electrodes lift dust particles away from the shield and repel charged particles. Deposited dust particles are removed from the dust mitigation device when the electrodes are activated, regardless of the resistivity of the dust. The invention further includes a method of mitigating dust using such components.

### CROSS-REFERENCE TO RELATED APPLICATIONS

This application claims priority pursuant to 35 U.S.C. 119(e) to co-pending U.S. Provisional Patent Application Ser. No. 61/792,826, filed Mar. 15, 2013, the entire disclosure of which is incorporated herein by reference.

### STATEMENT REGARDING FEDERALLY SPONSORED RESEARCH OR DEVELOPMENT

This invention was made with Government support under the terms of NAS10-03006 awarded by the National Aeronautics and Space Administration. The Government has certain rights in the invention.

### FIELD OF THE INVENTION

The present invention relates generally to devices and methods for removing deposited dust particles from and preventing charged particles from depositing on surfaces. More specifically, the present invention is concerned with utilizing electromagnetic fields to mitigate dust from a surface.

### BACKGROUND OF THE INVENTION

Dust accumulation on surfaces is problematic for a number of circumstances. For example, solar photovoltaic arrays are greatly degraded by the deposition of dust particles, which reduce the amount of light entering the array. There are many other devices that demand light transparency for optimal efficiency and for which dust deposits are problematic. For example, optical windows, such as those on cameras, optical or infrared detectors, windshields for aircraft, automobiles, and other vehicles are all optimally used when they are fully transparent, and dust deposition is problematic, particularly in windy or dry climates.

There are a host of other systems that degrade under the presence of dust accumulation that are not transparent such as thermal radiators, batteries, clothing, fans, and floors. Dust is similarly detrimental in various manufacturing and testing processes, and these problems are often addressed by conducting such processes in a clean room environment. Within clean rooms, there is often a desire to repel what particulates there are from certain apparatuses and surfaces.

Several devices known in the art utilize electromagnetic fields to mitigate dust from surfaces in which dust accumulation is problematic. For instance, U.S. Pat. No. 6,911,593 to Mazumder et al. discloses a transparent electromagnetic “dust” shield for protecting solar arrays and the like from dust deposition. In addition, U.S. Pat. No. 8,513,531 to Trigwell et al. discloses a flexible electrodynamic array for mitigating dust from flexible substrates, such as fabrics. Both Mazumder and Trigwell, as well as other similar prior art systems and methods, teach particle transportation by creation and manipulation of electromagnetic fields between adjacent electrodes of the shield.

In a typical “dust” shield of the prior art adjacent electrodes are separated by a dielectric material and different voltages are applied to each electrode to generate an electromagnetic field between the adjacent electrodes. Consequently, at least two separate power sources typically are required, or in some cases, a multi-phase power source is used to apply different phases of power to adjacent electrodes.

Depending on several factors, a short often can develop between adjacent electrodes of prior art shields. One factor is the voltage differential between the electrodes, which often is greater than the applied voltage. For instance, when a large positive voltage is applied to one electrode and a large negative voltage of similar magnitude is applied to an adjacent electrode, the differential voltage typically is roughly twice the value of the voltage applied to either electrode. Another factor is the distance between the electrodes. Because the distance between adjacent electrodes typically is relatively small and the differential voltage relatively large, the dielectric material is prone to failure, causing a short between the two electrodes. Even a single short between just two electrodes in an entire array of electrodes can render the entire electrode array inoperable. Therefore, it would be beneficial to provide a system and method for mitigating dust from a surface that is more robust and/or less likely to experience such failures.

In addition, the high voltage in the electrode array of prior art systems can also damage equipment and harm individuals that are in close proximity to the electrode array. Positioning a grounded layer between the electrode array and the equipment and/or an individual would potentially reduce this risk. Nevertheless, such positioning of a grounded layer in close proximity to an electrode array would also adversely affect the electromagnetic fields that are generated between the adjacent electrodes. Consequently, because a protective grounded layer tends to render the electrode array of prior art systems ineffective, such a layer is seldom, if at all, utilized. Therefore, it would be beneficial to provide a system and method for mitigating dust from a surface that is capable of full functionality while incorporating a protective grounded layer.

### SUMMARY OF THE INVENTION

The present invention provides a dust mitigation device and a method for using the device to mitigate dust from collecting on a surface. The device comprises at least one electrode (and in various embodiments, a plurality of electrodes), a grounded layer displaced from the electrode(s), and a dielectric layer separating the electrode(s) from the grounded layer. The method comprises generating transient electromagnetic fields by providing a transient, single-phase signal to each electrode from a single power source. In some embodiments, the power source is connected to each electrode individually. In some embodiments the electrodes are interconnected. Because the device of the instant invention is capable of continuing to function with adjacent electrodes being interconnected, an accidental short between any two electrodes that are not otherwise intentionally interconnected will not render the device inoperable.

When power is supplied to the electrodes of the present invention, electromagnetic fields are generated between the electrodes and the grounded layer. The electromagnetic fields are not confined to the area between the electrodes and the grounded layer. Instead, portions of the electromagnetic fields extend beyond the electrodes generally in all directions. It is this extended portion of the electromagnetic fields that is utilized to impart forces onto particles, such as dust particles. By fluctuating the power supplied to the electrodes, constantly varying forces are exerted on each particle until each particle migrates away from the influence of the electromagnetic fields.

A general object of this invention is to provide a dust mitigation device that utilizes electromagnetic fields to mitigate dust.

Another object of this invention is to provide a dust mitigation device, as aforesaid, that is capable of operating with a single power source.

Still another object of this invention is to provide a dust mitigation device, as aforesaid, that remains operable when electrodes are accidentally shorted and/or intentionally interconnected.

Yet another object of this invention is to provide a dust mitigation device, as aforesaid, that includes a grounded layer.

A further object of this invention is to provide a method of mitigating dust by providing a transient, single-phase signal to the aforesaid dust mitigating device.

Yet a further object of this invention is to provide a method of mitigating dust, as aforesaid, that includes fluctuating the aforesaid signal.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof

### BRIEF DESCRIPTION OF THE DRAWINGS

FIG. 1 is a perspective view of a dust mitigation device according to an embodiment of the present invention showing a plurality of electrodes positioned parallel to each other, a grounded layer positioned parallel to the electrodes, and a dielectric layer separating the electrodes from the grounded layer;

FIG. 2 is a perspective view of a dust mitigation device of an embodiment similar to that shown in FIG. 1, including additional electrodes running across the parallel electrodes so as to create a grid pattern of interconnected electrodes;

FIG. 3 is a perspective view of a dust mitigation device of an embodiment similar to that shown in FIG. 2, including a grounded layer comprising an interconnected array (grid) of conductive material;

FIG. 4 is a side view of an embodiment of a dust mitigation device similar to that shown in FIG. 1;

FIG. 5 is a side view of an embodiment of a dust mitigation device similar to that shown in FIG. 4, including an insulator and a coating, such as an antireflective coating, a semiconducting film, an infrared reflective film, a superhydrophobic coating, or the like.

FIG. 6 is a schematic representation of an embodiment of the present invention.

FIG. 7A is a schematic diagram representing an electromagnetic field generated by a dust mitigation device of the prior art.

FIG. 7B is a schematic diagram representing an electromagnetic field generated by a dust mitigation device of the present invention.

### DETAILED DESCRIPTION OF A PREFERRED EMBODIMENT

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Referring to FIG. 1, a dust mitigation device 5 of the present invention comprises a dielectric layer 10 separating a plurality of electrodes 20 from a grounded layer 30. The dielectric layer 10 is non-conducting and in some embodiments is transparent. The thickness and the rigidity of the dielectric layer 10 will be adjusted by those of ordinary skill in the art to provide necessary mechanical support and to allow for the suitable generation and penetration of electromagnetic fields. (See FIG. 7). The nature of the specific dielectric material chosen will be dependent on the use and conditions of the dust mitigation device 5. In various embodiments, the dielectric layer 10 is composed of various polymers, films, other dielectric substrate, glass, resin, plastic substrate, vacuum, epoxy, air, or any other suitable dielectric material.

In some embodiments the electrodes 20 are positioned on, near or generally proximate to the surface of the dust mitigation device 5. More specifically, as shown in any of FIGS. 1-3, in some embodiments the electrodes 20 are embedded in the dielectric layer 10. In such embodiments, the thickness and resistivity of the dielectric layer 10 is designed to allow the electromagnetic fields to penetrate sufficiently through a first surface 12 of the dielectric layer 10 away from the grounded layer 30 while also allowing the electromagnetic fields to penetrate sufficiently through a second surface 14 of the dielectric layer 10 (that is generally opposing the first surface 12) towards the grounded layer 30.

In other embodiments the electrodes 20 lie on top of the dielectric layer 10 and some such embodiments are affixed to the top surface 12 of dielectric layer 10, as shown in FIG. 4. It will be appreciated that the manner of affixing electrodes 20 to surface 12 of dielectric layer 10 will be readily apparent to those of ordinary skill in the art. As shown in FIG. 5, use of an insulator 40 separating the electrodes 20 from air is used to prevent or reduce likelihood of sparking of the current generated through the electrodes 20 to air if the dust mitigation device 5 is used in air. In some embodiments, the electrodes 20 are arranged to optimize coverage over the area of the dielectric layer 10 and over which dust is to be repelled. In some embodiments the arrangement of electrodes 20 forms an irregular pattern. In other embodiments the arrangement of electrodes 20 forms a generally uniform pattern as is shown in the embodiments discussed herein. In FIG. 5, an exterior surface 42 of the insulator 40 is the surface that typically is exposed to dust. A bottom surface 35 of the grounded layer 30 is not necessarily exposed to dust. Nevertheless, in various embodiments, the bottom surface 35 of the grounded layer 30 is exposed to dust. In some embodiments, the exterior surface 42 of the insulator 40 is coated with antireflective, superhydrophobic, or other coatings 50 as the application requires.

In some embodiments, such as that shown in FIG. 1, the electrodes 20 are desirably in a parallel linear array. In some embodiments, the electrodes 20 are all interconnected or intentionally ‘shorted’ with each other. For example, most of the electrodes 20 are in a linear array as shown in FIG. 1 with at least one electrode that crosses each of those arranged in parallel. The electrodes 20 need not be parallel as in FIG. 1 but in some embodiments are in a grid pattern, such as shown in FIG. 2. Other embodiments include any other suitable arrangement of electrodes 20.

In some preferred embodiments, the electrodes 20 are metal wires, such as copper wires, metallic grids, or metal mesh. Such metal “wires” need not be cylindrical in shape, and in various embodiments include metal films and deposition of conductive material using other means, such as plating or plating/etching processes. In another preferred embodiment, the electrodes 20 are comprised of a conducting transparent material such as thin films of indium tin oxide. In another preferred embodiment, the electrodes 20 are comprised of carbon nanotube wires.

In some embodiments of the invention, the electrodes 20 are comprised of conducting strips. In some such embodiments such conducting strips are transparent.

The present invention includes a dust mitigation device 5 that both removes deposited dust particles from its surface and repels charge particles, thus preventing deposition of particles. Dust and other particles typically consist of various different materials with different electrical properties, including, but not necessarily limited to, being conducting, semi-conducting, or insulating. To remove uncharged particles deposited on the surface and repel charged particles from the surface, a plurality of electrodes 20 are preferably embedded in or located adjacent to a dielectric layer 10 having high resistivity.

In various embodiments, the grounded layer 30 is a solid or solid transparent conductive layer as in FIG. 1, FIG. 2, FIG. 4, and FIG. 5. Alternately, in other embodiments the grounded layer 30 is comprised of an interconnected array (grid) of grounded conductive material as shown in FIG. 3. In some embodiments, the grounded layer 30 also is comprised of the metal or other conductive surface of the structural device or element from which dust is intended to be repelled or removed. In various embodiments such grounded layers 30 are made of a conductive material in various shapes and forms, such as a metal mesh, a physically or chemically deposited metal layer, a metal foil, or any other conductive material. In some embodiments, such grounded layer 30 need only be conductive, grounded, separated from the electrodes 20 by the dielectric layer 10, and in some embodiments preferably approximately parallel in space to the electrodes 20. In a preferred embodiment, the grounded layer 30 is comprised of a metal backed insulator such as copper coated polyimide. In another preferred embodiment, the grounded layer 30 is comprised of a metal mesh, such as an aluminum coating on Polyethylene Terephthalate (PET).

One distinguishing feature of some embodiments of the present invention over the prior art is that the electrodes 20 are all capable of being connected to a single power source 100 such that all electrodes 20 experience the same voltage at the same time. (See FIG. 6). Consequently, any possible voltage differential between electrodes 20 is negligible, reducing the likelihood of an accidental short between electrodes 20. In the event a short does occur between electrodes 20; however, the dust mitigation device 5 remains operable.

Another distinguishing feature of some embodiments of the present invention over the prior art is the relatively close proximity of the grounded layer 30 to the electrodes 20. This relatively close proximity helps to protect equipment and people from the potential high voltage in the electrodes 20. In the prior art, where particle transportation relies on differential voltages between adjacent electrodes 20, a grounded layer 30 located in close proximity to the electrodes 20 would interfere with the operability of the system.

Yet another distinguishing feature of some embodiments of the present invention over the prior art is the use of a single power source 100 to operate the dust mitigation device 5. In some embodiments the power source 100 is operatively connected to the electrodes 20 and the grounded layer 30 such that the power source 100 provides a transient high voltage signal to the electrodes 20. One preferred method of applying a transient voltage to the dust mitigation device 5 is to use a spark gap method, as it is simple and minimizes power. Nevertheless, other methods of applying a transient voltage are used in other various embodiments, including but not limited to applying a square waveform generated by a high voltage amplifier, chopping a DC high voltage signal by high voltage switches, and using other methods that are now known to or hereinafter discovered by those of ordinary skill in the art.

In some embodiments, the power source 100 is desirably designed to have a low power requirement and be compact in size. In some embodiments the power source 100 is capable of operating manually. In other embodiments it operates automatically, such as by using a sensor that detects the dust level on the surface of the dust mitigation device 5. In some embodiments the power source 100 is a separate element. In other embodiments, particularly in cases where the device to be protected is itself a power source 100 (i.e., photovoltaic cells), the power for the invention is obtained from the structure from which dust is repelled by the device 5.

It is important to note that in some embodiments the electrodes 20, the dielectric layer 10, and the grounded layer 30 are not exclusive elements of the dust mitigation device 5. Consistent with the functionality of the device or mechanism from which dust is to be repelled, in various embodiments there are intervening materials between such layers, and in particular between the dielectric layer 10 and the grounded layer 30. Similarly, in some embodiments adhesive layers also are used. As shown in the embodiments in FIGS. 1-3, it is not necessary for functionality that the dielectric layer 10 and the grounded layer 30 be directly connected to each other. In some such embodiments, the grounded layer 30 is spaced apart from the dielectric layer 10. Nevertheless, in some embodiments, the dielectric layer 10 is directly connected to the grounded layer 30.

In some embodiments, devices/systems of the invention are used as a stand-alone device. In some such embodiments, the device is attached to or positioned over or in close proximity to a surface from which dust is to be removed or prevented from collecting. In other embodiments, devices/systems of the invention are associated with another device, which includes one or more surface from which dust is to be removed or prevented from collecting. In various such embodiments in which the devices/systems of the invention are associated with or incorporated into other devices, the associated devices include a thermal radiator, a garment, or any other device that is or is capable of being made with multilayer materials.

In some embodiments including thermal radiators, which are often made from a multilayer composite material, the electrodes 20, the dielectric layer 10, and the grounded layer 30 are made with or incorporated into the multilayer materials of the thermal radiators themselves. For example, in some such embodiments the electrodes 20 are etched onto the metallic surface of one of the layers of the thermal radiator, such as copper. Another layer of the thermal radiator, such as in some embodiments polyimide, serves as the dielectric layer 10 while another metallic layer of the thermal radiator (in various embodiments etched or unetched) serves as the grounded layer 30.

In various embodiments of a garment, the dielectric layer 10, the electrodes 20, and/or the grounded layer 30 are comprised of flexible materials that at least in part make up the garment. In some embodiments the dielectric layer 10 is comprised of polypropylene or another suitable material with a grid of electrodes 20 woven within the layer 10. Examples of suitable electrode materials for such an application include, but are not limited to, carbon-based continuous filament conductive yarn or continuous filament carbonized nylon. Preferably, the electrodes 20 are comprised of a material having a conductivity of 6 Megaohms per inch or greater. In some embodiments, grid spacing is that of traditional garments, preferably about 4 mm by 5 mm spacing. In various embodiments, such a grid is sewn into the outer layer of another fabric, such as on a space suit, or with any insulating fabric.

In another garment embodiment, the dielectric layer 10 preferably has a thickness of at least 1 mil and, more preferably, a thickness of 1-2 mils. In one preferred embodiment the dielectric layer 10 is comprised of a polyimide film, such as those sold under the name Kapton, with a breakdown strength of at least 3 kV/mil.

Although directly applying the grounded layer 30 to the dielectric layer 10 would not necessarily hinder the performance of the dust mitigation device 5, there is no requirement to do so. Thus, in some embodiments the grounded layer 30 is separated from the dielectric layer 10. For example, spacesuits generally have alternating layers of metal films and insulating films integrated into the suit. In some embodiments, one or more of said metal films is grounded to serve as the grounded layer 30. Similarly, in some embodiments based upon current spacesuit designs, the Kapton layer plus air serve as the dielectric layer 10 in the present invention. In other embodiments, the dielectric layer 10 is directly applied to the grounded layer 30.

Other embodiments of the present invention are used with a photovoltaic array (not shown). In some such embodiments, the device 5 is placed over the surface of the photovoltaic array. In some such embodiments, the dielectric layer 10 and the electrodes 20 are transparent. In some embodiments, if the grounded layer 30 is positioned between the dielectric layer 10 and the photovoltaic array, the grounded layer 30 will also be transparent. In some embodiments, when used for this and similar applications, the power source 100 is obtained from the photovoltaic array itself

In some embodiments used with photovoltaic arrays, the electrodes 20 are embedded within the dielectric layer 10 and dust particles will deposit on a first surface 12 of the dielectric layer 10. As dust particles accumulate, light passing through the dielectric layer 10 towards the photovoltaic array is diminished, thereby diminishing the efficiency of conversion of incident light to energy. In some such embodiments, the energy output is measured by a monitor. In various such embodiments, such a monitor is powered using an independent power source 100 or by the photovoltaic energy output. Similarly, in some embodiments such monitor is used to trigger application of the transient voltage to the electrodes 20. In other words, the monitor is connected to a power source 100 such that the power source 100 is activated to power the electrodes 20 at a specified degree of obscuration.

When used with a photovoltaic array or other similar application, it is preferred in some embodiments that the first surface 12 of the dielectric layer 10 be coated with an infrared reflective coating to minimize heating of the photovoltaic array. To be clear, the first surface 12 of the dielectric layer 10 is opposed to the grounded layer 30. In some embodiments the dielectric layer 10 also includes a second surface 14 opposed to the first surface 12. In some embodiments the second surface 14 of the dielectric layer 10 is in contact with the photovoltaic member. In other embodiments the second surface 14 of the dielectric layer 10 is in contact with a top surface 32 of the grounded layer 30. In some embodiments in which the grounded layer 30 is positioned between the dielectric layer 10 and the photovoltaic member, a bottom surface 35 of the grounded layer 30 is in contact with the photovoltaic member.

As shown in FIG. 5, in some embodiments the exterior surface 42 of the insulator 40 is coated with a thin, preferably transparent, semiconducting film 50. The semiconducting film 50 is fabricated from a semiconducting material that has controlled surface resistivity such that electrostatic charges accumulated on the exterior surface 42 of the insulator 40 are allowed to decay at a controlled rate. In another embodiment, the semiconducting film 50 is applied to the first surface 12 of the dielectric layer 10.

The semiconducting film 50 provides tribocharging between the initially uncharged or very lowly charged particles that come into contact with it. Contact and movement of the particles in relation to the semiconducting film 50 and the electromagnetic field cause the initially uncharged or lowly charged particles to attain a charge of sufficiently high levels so that the particles are ejected from the dust mitigation device 5, thus accomplishing the dust removal. In some embodiments the chemical composition of the semiconducting film 50 is such that the electrostatic charges left on it have a leakage path to ground through it. In some embodiments it will further have sufficiently high resistivity such that the electromagnetic field is capable of penetrating the semiconducting film 50 so as to provide particle transport.

To improve removal of dust particles as well as particles embedded in a water soluble mixture such as mud, in some embodiments it the exterior surface 42 of the insulator 40 (as shown in FIG. 5) is coated with a superhydrophobic coating 50. Such coating further repels mud and water from adherence to the exterior surface 42. In another embodiment, the superhydrophobic coating 50 is applied to the first surface 12 of the dielectric layer 10.

Some preferred embodiments, such as in photovoltaic arrays, also include an infrared reflective film 50 on the exterior surface 42 of the insulator 40 such that infrared radiation that would otherwise become incident to the device and have negative effects, such as raising its temperature and reducing efficiency of solar energy conversion to electricity, is reflected. In some such embodiments, the dust mitigation device 5 also acts as a heat shield.

For some embodiments of laser-based or other optical systems, preferably the bottom surface 35 of the grounded layer 30 has antireflective properties to prevent dust accumulation. In some embodiments such antireflective properties are obtained with an antireflective coating. In another embodiment, the second surface 14 of the dielectric layer 10 includes antireflective properties.

In some embodiments, the electrodes 20 are connected to a single transient high voltage signal. There is greater dust removal efficiency for embodiments utilizing large transient fast-changing signals such as square wave or pulse signals, including a pulsed transient signal. Such signals are derived from spark-gap circuits that use very little power. In some embodiments this power is derived from a solar panel itself without the use of an external power source 100.

When the dust mitigation device 5 is present on other systems that do not generate their own power, in some embodiments typical square wave voltage signals are applied using a high voltage DC source that is switched rapidly on or off or a system of high voltage amplifiers of sufficient rise times.

The present invention also includes a method of preventing and removing dust particle deposition as explained herein. The method includes supplying a plurality of electrodes 20, at least one grounded layer 30 displaced from the electrodes 20, and at least one dielectric layer 10 separating the electrodes 20 from the grounded layer 30 so as to create a dust mitigation device 5. In some embodiments, the electrodes 20 are interconnected. In other embodiments, the electrodes are not interconnected. The method also includes providing a transient, single-phase signal to the electrodes 20 of the dust mitigation device 5. In some embodiments the single-phase signal is a single-phase AC signal supplied by a power source 100. In some such embodiments the signal is fluctuated so as to fluctuate electromagnetic fields that are generated by the method.

Some embodiments of the invention employ a monitoring and/or detection device (not shown) that is capable of measuring the degree of obscuration of a screen, transparent material, or other element. In some embodiments, upon reaching a threshold level, the monitoring and/or detection device activates the power source 100 to power the electrodes 20. Such on-demand operation of the dust mitigation device 5 helps to reduce the power requirements for the dust mitigation device 5 and, in the case of photovoltaic arrays and other power-supplying devices, maximize the net power output.

One example of the application of the present invention is a thermal radiator. Typical thermal radiators used for space applications are comprised of a transparent fluorinated ethylene propylene (FEP) or Teflon-FEP, which is a copolymer of hexafluoropropylene and tetrafluoroethylene. The FEP is then coated with a thin layer of either silver with Inconel or aluminum for reflectivity to give it its thermal properties. This material is commonly called Second Surface Mirror (SSM) in the aerospace industry.

In some embodiments a dust mitigation device 5 is made by etching a grid pattern into the metallic surface of a first SSM (not shown) using conventional techniques (chemical etching, photolithograpy, or other techniques known to those of ordinary skill in the art). In some such embodiments the grid pattern is comprised of 4 mm by 5 mm rectangles. It will be appreciated that other embodiments include various grid patterns and geometries. In some embodiments, a second SSM (not shown) is affixed to the first SSM such that the FEP layer of the first SSM serves as an insulator 40, the etched metallic grid serves as a plurality of electrodes 20, the FEP layer of the second SSM serves as a dielectric layer 10, and the solid metallic layer of the second SSM serves as a grounded layer 30. This configuration, and other similar configurations, provide the same thermal properties as an un-etched SSM while allowing for dust mitigation.

In some embodiments dust mitigation is provided by grounding the grounded layer 30 and applying an alternating square wave high voltage signal to the electrodes 20. IN some embodiments voltages used will be 3000 volts at about 10-50 Hz. A 1 mil thick FEP having a dielectric strength of 6500 V/mil is sufficient to prevent electrical breakdown between the electrodes 20 and the grounded layer 30. Nevertheless, it will be appreciated that other materials and thicknesses are utilized in other various embodiments. Upon application of the voltage, dust particles typically are sufficiently removed within a few seconds.

It is understood that while certain forms of this invention have been illustrated and described, it is not limited thereto except insofar as such limitations are included in the following claims and allowable functional equivalents thereof

What is claimed is:

1. A dust mitigation device comprising:
a dielectric layer, said dielectric layer including a first surface and a second surface generally opposing said first surface;
at least one electrode located generally proximate to one of said first or second surfaces;
a grounded layer displaced from said at least one electrode and located generally proximate to an other of said first or second surfaces; and
a power source operatively connected to said electrodes and to said grounded layer;
wherein said dielectric separates said at least one electrode from said grounded layer.

2. The dust mitigation device as in claim 1, wherein said at least one electrode comprises a plurality of electrodes that are interconnected.

3. The dust mitigation device as in claim 1, wherein said at least one electrode is embedded in said dielectric layer.

4. The dust mitigation device as in claim 1, wherein said grounded layer is comprised of an interconnected array of grounded conductive material.

5. The dust mitigation device as in claim 1, wherein at least one of said grounded layer, said dielectric layer, and said at least one electrode are comprised of flexible materials.

6. The dust mitigation device as in claim 5, wherein said at least one electrode comprises a plurality of electrodes that are interconnected.

7. The dust mitigation device as in claim 1, wherein at least one of said dielectric layer and said at least one electrode are transparent.

8. The dust mitigation device as in claim 7, further comprising a detection device measuring the obscuration by dust of light passing through said transparent dielectric layer wherein said detection device is connected to said power source such that said power source is activated to power said at least one electrode at a specified degree of obscuration.

9. The dust mitigation device as in claim 7, wherein said one of said first or second surfaces of said dielectric layer includes an infrared reflective coating.

10. The dust mitigation device as in claim 9, wherein said one of said first or second surfaces of said dielectric layer located generally proximate to said at least one electrode includes an infrared reflective coating.

11. The dust mitigation device as in claim 10, wherein said grounded layer is transparent.

12. The dust mitigation device as in claim 7, wherein:
said grounded layer is transparent; and
said one of said one of said first or second surfaces of said dielectric layer located generally proximate to said ground layer includes an antireflective coating.

13. The dust mitigation device as in claim 12, wherein:
said grounded layer includes a top surface; and
said one of said first or second surfaces of said dielectric layer located generally proximate to said grounded layer is positioned adjacent to and in contact with said top surface of said grounded layer.

14. The dust mitigation device as in claim 1, wherein said one of said first or second surfaces of said dielectric layer located generally proximate to said at least one electrode includes a superhydrophobic coating.

15. The dust mitigation device as in claim 1, wherein said power source provides a pulsed transient signal to the electrodes.

16. The dust mitigation device as in claim 1, wherein said at least one electrode is located generally adjacent to said dielectric layer.

17. A method of preventing and removing dust particle deposition from a surface, comprising:
supplying:
at least one dielectric layer, said dielectric layer including a first surface and a second surface generally opposing said first surface;
at least one electrode located generally proximate to one of said first or second surfaces; and
at least one grounded layer displaced from said at least one electrode and located generally proximate to an other of said first or second surfaces; and
separating said at least one electrode from said grounded layer via said dielectric layer; and
providing a transient, single-phase signal to said at least one electrode.

18. The method as in claim 17, wherein said at least one electrode includes a plurality of electrodes that are interconnected.

19. The method as in claim 17, wherein said signal is fluctuated so as to fluctuate electromagnetic fields generated by said at least one electrode.
